(19) United States
(12) Patent Application Publication
(10) Pub. No.: US 2023/0402848 A1
(43) Pub. Date: Dec. 14, 2023

(54) ENERGY STORAGE OPTIMIZATION SYSTEM

(71) Applicant: THE ENERGY AUTHORITY, INC., Jacksonville, FL (US)

(72) Inventors: Eina OOKA, Bellingham, WA (US); Gaurav MAHAMUNI, Seattle, WA (US); Sean MACKEY, Minneapolis, MN (US); Kevin POON, Jacksonville, FL (US)

(21) Appl. No.: 18/208,033

(22) Filed: Jun. 9, 2023

Related U.S. Application Data
(60) Provisional application No. 63/351,084, filed on Jun. 10, 2022.

(51) Int. Cl. H02J 3/32; H02J 3/00; H02J 3/38; G06Q 50/06

(52) U.S. Cl. CPC H02J 3/32; H02J 3/004; H02J 3/381; G06Q 50/06; H02J 2203/10; H02J 2203/20

(57) ABSTRACT

Methods and systems for renewable energy and storage hybrid resource forecasting and optimization, via an energy storage optimization system, against independent system operator (ISO) market values while accounting for dispatch variabilities in services.

### CROSS-REFERENCE TO RELATED APPLICATIONS

This application claims the benefit of U.S. Provisional Patent Application No. 63/351,084, filed Jun. 10, 2022, entitled “Battery Storage Optimization Model,” the entire content of which is incorporated herein by reference.

### TECHNOLOGICAL FIELD

The present disclosure generally relates to methods, apparatuses, and computer program products for a collaborative platform.

### BACKGROUND

An independent system operator (ISO) is an organization formed at the recommendation of the Federal Energy Regulatory Commission (FERC). In the areas where an ISO is established, it may coordinate, controls, and monitors the operation of the electrical power system, usually within a single US state, but sometimes encompassing multiple states. Regional transmission organizations (RTOs) typically perform the same functions as ISOs but cover a larger geographic area. An ISO operates a region's electricity grid, administers the region's wholesale electricity markets, and provides reliability planning for the region's bulk electricity system.

This background information is provided to reveal information believed by the applicant to be of possible relevance. No admission is necessarily intended, nor should be construed, that any of the preceding information constitutes prior art.

### BRIEF DESCRIPTION

Disclosed herein are methods, devices, or systems for renewable energy and storage hybrid resource forecasting or optimization. which may consider independent system operator market values. The disclosed methods or systems may account for renewable energy services or ancillary services dispatch uncertainties to act as a dispatchable resource, which may be in an independent system operator (ISO) market. Processes may be: (1) continuously run to take in unsolicited operations data, (2) periodically run (e.g., every 5 min) to make operational data available for live system monitoring, (3) periodically run (e.g., every 15 min) to make data available for the forecast or optimization system runs, (4) periodically run (e.g., every hour) to forecast or optimize, or (5) periodically run (e.g., daily) to clean up the data or make summary results available.

This Brief Description is provided to introduce concepts in a simplified form that are further described below in the Detailed Description. This Brief Description is not intended to identify key features or essential features of the claimed subject matter, nor is it intended to be used to limit the scope of the claimed subject matter. Furthermore, the claimed subject matter is not limited to solving any or all disadvantages noted in any part of this disclosure.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates an energy storage optimization system;

FIG. 2 illustrates logical interconnections and components associated with an energy storage optimization system;

FIG. 3 is an example of a plot with regard to how error bounds may increase over a period;

FIG. 4 is an exemplary instance of a forecast result; and

FIG. 5 illustrates an exemplary flow chart of energy storage optimization.

FIG. 6 is an exemplary block diagram representing a computing system in which aspects of the methods and systems disclosed herein or portions thereof may be incorporated.

The figures depict various examples for purposes of illustration only. One skilled in the art will readily recognize from the following discussion that alternative examples of the structures and methods illustrated herein may be employed without departing from the principles described herein.

### DETAILED DESCRIPTION

As defined herein a “computer-readable storage medium,” which refers to a non-transitory, physical, or tangible storage medium (e.g., volatile, or non-volatile memory device), may be differentiated from a “computer-readable transmission medium,” which refers to an electromagnetic signal.

As referred to herein, an “application” or “app,” may refer to a computer software package that may perform specific functions for users or, in some cases, for another application(s). An application(s) may utilize an operating system (OS) or other supporting programs to function. In some examples, an application(s) may request one or more services from, or communicate with, other entities via an application programming interface (API).

As referred to herein a “bid,” may refer to a monetary or value proposal or offer to a marketplace (e.g., centralized market or energy market) to increase demand or reduce energy generation.

As referred to herein a “grid,” may refer to a network of synchronized power or energy providers or consumers that are connected by transmission or distribution lines operated by one or more control centers.

An independent system operator (ISO) is an organization formed at the recommendation of the Federal Energy Regulatory Commission (FERC). In the areas where an ISO is established, it may coordinate, control, or monitor the operation of the electrical power system, usually within a single US state, but sometimes encompassing multiple states. Regional transmission organizations (RTOs) typically perform the same functions as ISOs but cover a larger geographic area. An ISO operates a region's electricity grid, administers the region's wholesale electricity markets, or provides reliability planning for the region's bulk electricity system.

As more renewable energy systems or resources are used in power grids, there may be a lack of consideration of forecasted energy generation by less-than-ideal conditions for renewable energy generation (e.g., cloudy, or rainy conditions that affect solar energy generation). In such an example, the resultant market price (e.g., market value) may reflect a drastic change in the energy generation of the solar resource, corresponding to increased values associated with energy services (e.g., trade or supply of energy or energy generation) to users. As referred to herein, a value may refer to a price or a rate for a product associated with a market. Disclosed herein are methods, systems, or apparatus that may provide for an energy storage optimization system. The energy storage optimization system may forecast information based on received data (e.g., historical data, etc.) and determine an operational configuration of a hybrid system or bidding strategy for optimal hybrid resource usage.

The disclosed subject matter may enable functions that may help optimize system operations associated with energy management or purchase. For example, the disclosed subject matter may enable hybrid resource owners to optimize hybrid system operations within an independent system operator (ISO) market or similar markets.

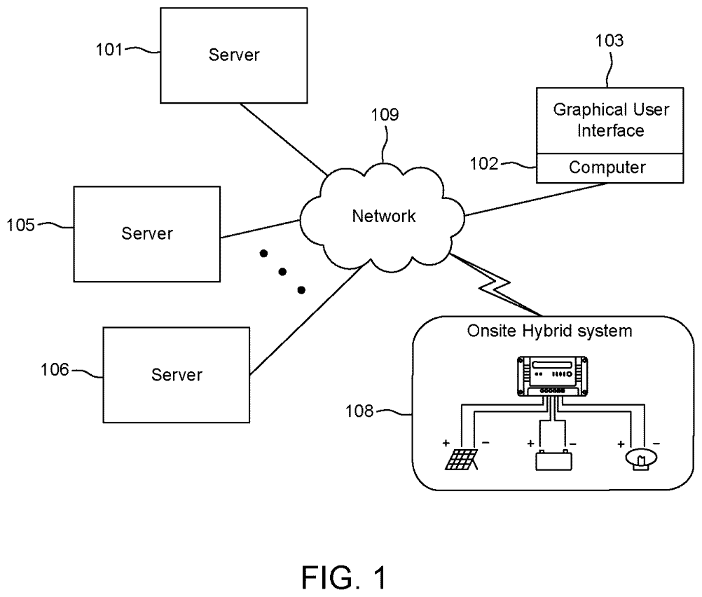

FIG. 1 illustrates an energy storage optimization system. The energy storage optimization system may be capable of facilitating communications among entities or provisioning of data among entities. Energy storage optimization system may include device 102, server 101, server 105, server 106, or hybrid system 108. Network 109 may communicatively connect server 101, server 105, server 106, or device 102. Display (e.g., user interface 103) may be connected with device 102. A user interface 103 may be generated that displays information associated with the energy storage optimization system. In an example, server 101 may receive information or process information from server 105 (e.g., metrological data), server 106 (e.g., on-site load data which may be received from on-site hybrid system 108), or other servers, databases, and the like. Server 101 may then transmit energy storage optimization information to device 102 for further processing. Energy storage optimization information may be shown on a display (e.g., user interface 103). Device 102 may determine the appropriate user interface functionality or user interface appearance based on the selected energy storage optimization system parameters or functionality.

Although FIG. 1 illustrates an example arrangement of devices or networks. The devices of energy storage optimization system may be physically or logically co-located with each other in whole or in part.

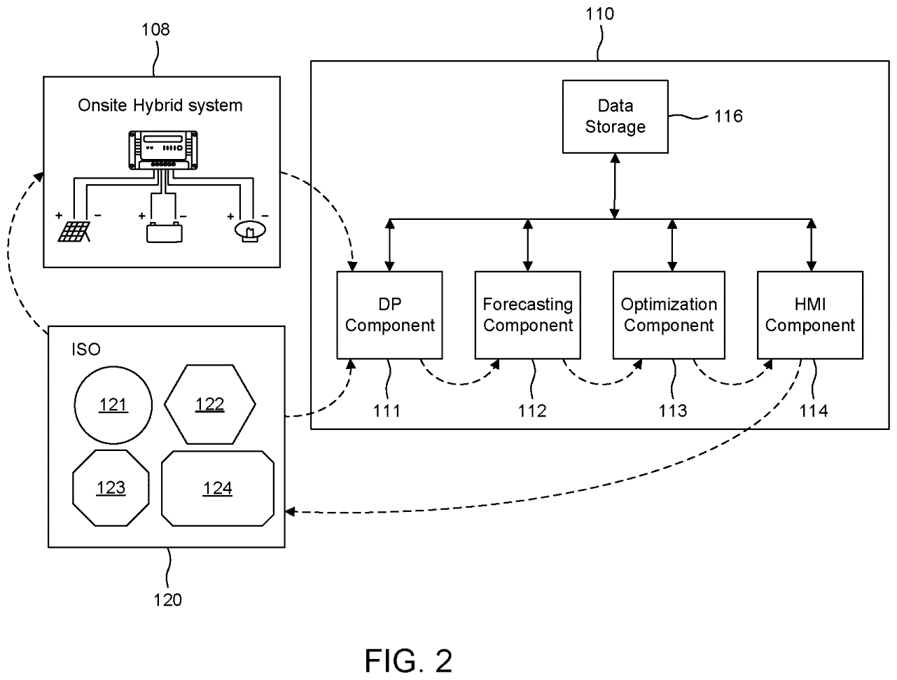

The disclosed energy storage optimization system may have multiple components that may work together or independently as further described herein. FIG. 2 illustrates logical interconnections or logical components associated with an energy storage optimization system. There may be an operator system 120 (e.g., ISO 121, ISO 122, ISO 123, or ISO 124) that communicates with an on-site hybrid system 108 and energy storage optimization system 110. Energy storage optimization system 110 may have multiple logical components that may be executed on one or more servers (e.g., server 101). Operator system 120 may have multiple logical components that may be executed on one or more servers (e.g., server 105 or server 106)

As disclosed in more detail herein, component 111 may be associated with data processing (herein DP component 111), component 112 may be associated with forecasting (herein forecasting component 112), component 113 may be associated with optimizations (herein optimization component 113), and component 114 may be associated with human-machine interaction (HMI) (herein HMI component 114).

DP component 111 may include obtaining (e.g., receiving) live data associated with a hybrid system 108 (e.g., energy storage or renewable energy generation) associated with a hybrid resource and providing data for modeling or reporting.

Data associated with the hybrid system may be received via DP component 111 by communicating with an on-site controller associated with a hybrid system (e.g., hybrid system 108). An example implementation may utilize Distributed Network Protocol 3 (DNP3) protocols (also known as IEEE Std 1815) and may receive a live data feed. The received live data may include the following data: system status, the latest (e.g., real-time or within an updated period) solar generation data, on-site metrological data, the state of charge of a battery system, or on-site loads, among other things. The data may be aggregated or adjusted into a usable format and stored in data storage system 116. In some examples, data storage system 116 may be used to store various types of information. In particular examples, the information stored in data storage system 116 may be organized according to specific data structures. In particular examples, each of the data storage system 116 may be a relational, columnar, correlation, or other suitable database.

Energy storage optimization system 110, via DP component 111, may receive market data associated with an operator system 120 (e.g., ISO 121-ISO 124) or other energy data feeds (e.g., regional generation, outage forecast, load forecast, etc.). Technology may differ between markets, but some market data may come from an independent system operator system (ISO) (e.g., ISO 121) directly via an application programming interface (API), from commercially data providers, or an organization's (e.g., a scheduling coordinator) internal data management systems. The received market data may be processed via DP component 111 into one or more formats for components (e.g., forecasting component 112, optimization component 113, or HMI component 114) for energy storage optimization system 110 general use or storage (e.g., data storage system 116). The data tasks associated with data processing may be set to be performed continuously or periodically processed (e.g., scheduled tasks every 5-min or 15-min). It is contemplated that the tasks associated with data processing may be set at any suitable period of time. As disclosed herein market data, live data, or some combination thereof may be referred to as data.

Forecasting component 112 may include different types of forecasting. There may be a forecasting of future renewable energy generation (e.g., solar, wind, electric vehicle (EV) load, or other energy generation or load) as a range of potential outputs. In another example, there may be a forecasting of market values (e.g., energy, regulation up, regulation down, or spin values) as a set of potential scenarios with likelihood of occurrences. Correlations between market values may be captured as well as synchronized spiking behavior. In some examples market values may further comprise regional market data, wherein regional market data may be energy, regulation up, regulation down, or spin values associated with a specific region, location, state, city, etc.

Energy storage optimization system 110, particularly forecasting component 112, may include a renewable energy generation forecast model which may utilize information associated with data of DP component 111, such as on-site renewable energy generation data, metrological data, vendor-provided weather forecast, or ISO's generation forecast. In addition to an expected generation forecast, the disclosed renewable energy (e.g., solar) prediction may generate dynamically adjusted high or low forecasts. The generated forecast information (e.g., renewable energy generation data) may be saved (e.g., data storage system 116) back into the energy storage optimization system 110 together with other related data.

The renewable energy generation forecast model may generate expected, high, or low ensemble forecasts, where a range of possible generations may be adjusted based on the weather patterns observed in historical generation data. In some examples, renewable energy generation model may utilize a machine-learning model, such as random forest to generate expected, high, or low ensemble forecasts.

Random forest may operate like the “wisdom of the crowd.” Random forest may generate many weak forecasts, called trees, by perturbing training datasets. Random forest as implemented may take the average of the trees to find the final forecast values. The expected forecast values may be generated by applying this random forecast methodology. The energy storage optimization system may utilize percentile values of the forest trees to generate high or low forecasts.

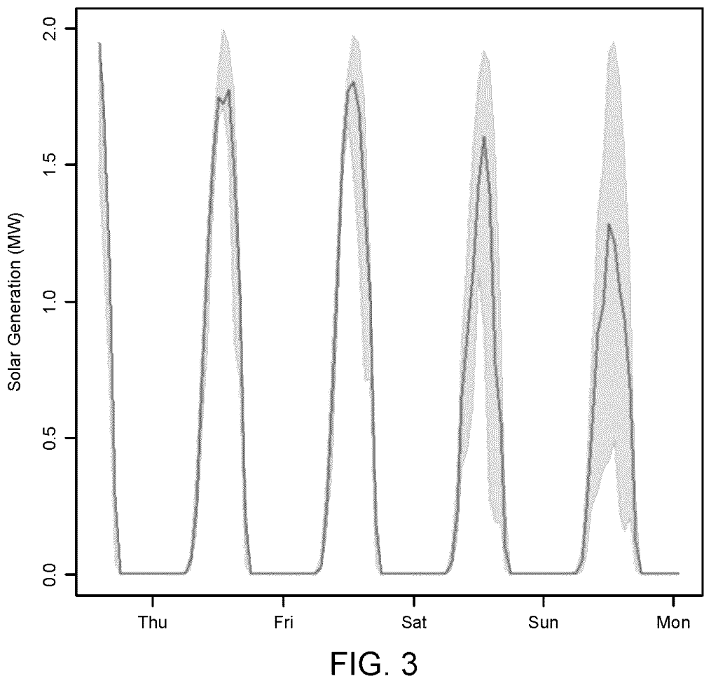

Existing stochastic or high/low forecasting methods may assume errors to be independent and identically distributed (i.d.d.). For this reason, it may be challenging to extract uncertainties (e.g., variabilities) in the data that may vary based on external conditions. However, the disclosed subject matter may directly calculate percentiles off random forest trees which may enable dynamically adjusted error bounds around the expected values. The plot in FIG. 3 is an example plot with regard to how error bounds may increase over a few days as the weather turns overcast or rainy.

The data used in the renewable energy forecasting model may include historical generation or load data (or estimated generation data), historical outage data, historical weather data, or vender-subscription weather forecast for the coming 10-days, among other things. In some particular examples, data comprising historical generation or load data, historical outage data, historical weather data, or vendor-subscription weather forecast for the coming 10-days, among other things, may be used as training data for the renewable energy forecasting model.

Energy storage optimization system 110 may further include a market value forecast model. The market value forecast model may utilize the data (e.g., market data, live data, or any other suitable data) associated with DP component 111 or renewable energy generation forecast model data of forecasting component 112 to generate market values. DP component 111 may receive market data via operator system 120 (e.g., ISO 121-ISO 124). The market value forecast model may generate market values (e.g., energy, regulation-up, regulation-down, or spin) in the form of scenarios or associated probabilities. The generated market values may be saved back (e.g., data storage system 116) into the energy storage optimization system 110 together with other related data.

The market value forecast model may generate a specified number of 2-day-long value scenarios and associated probability of occurrence, designed to be input into the stochastic optimization engine (herein, may be used interchangeably with and may be considered as an optimization model) component (e.g., optimization component 113). It is to be contemplated that the market value forecast model may generate value scenarios of any time interval (e.g., second, minute, hour, day, week, month, year, etc.) associated with the specified number of value scenarios and associated probability of occurrence; for example, the market value forecast model may generate a specified number of 1-week-long value scenarios and associated probability of occurrence.

ISO's markets may be open to multiple product offerings. One of the products that may be traded and settled at day-ahead or real-time markets is “energy.” In some particular examples, markets that frequently trade energy may also be referred to as energy markets. Such markets may refer to commodity markets that deal specifically with the trade or supply of energy (e.g., energy generation), herein may also be referred to as energy services. An energy market may also be referred to as electric power markets or electricity markets that may also refer to other sources of energy, such as natural gas, oil, hydroelectric, solar, or the like. In some examples, markets may relate to petroleum or fuel markets where the market may frequently distribute, transfer, trade, or sale of petroleum products.

For example, a market participant may desire to produce 50 megawatts (MW) power at Hour-Ending 3 (HE3) and bid 50 MW energy for HE3. The market would accept it, and that market participant would deliver flat 50 MW energy for the entire HE3. As referred to herein, HE3 (Hour-Ending 3) may refer to consecutive sixty-minute period ending at 3:00, such as, the time period from 2:00 am to 3:00 am. Alternatively, a market participant may offer “ancillary services” products in the day-ahead or real-time markets. Ancillary services may refer to functions that may help grid operators maintain a reliable energy system. Ancillary services may help maintain the proper flow and direction of energy, address imbalances between supply and demand, or help the hybrid system recover after a power system event. In some examples where the hybrid system may comprise significant variable renewable energy penetration (e.g., wind, solar, hydroelectric, etc.), additional ancillary services may manage increased variability or uncertainty.

Within ancillary services, there are regulation-up, regulation-down, or spin products that may be particularly profitable (e.g., gain) for battery systems. These products may provide grid resiliency reserves to ramp up or ramp down at without ample time prior to notice (e.g., last-minute). For example, if a market participant can make 50 MW capacity available at HE3 as regulation-up, the ISO system (e.g., ISO 120) may accept it and pay for the reserve to be available for within-the-hour dispatch calls. This may be followed by real-time operation of ISO sending dispatch signals every 4 seconds to the system so that the market participant's generation may go up or down between 0 and 50 MW every 4 seconds.

Energy services or ancillary services market values may have a strong correlation; when energy values goes up, regulation-up value most likely goes up as well. Also, both energy services and ancillary service values can have extreme spikes. For example, a product may be trading at $30 this hour and spike up to $200 in the next hour. This type of multiple-commodity correlation and extreme spiking behavior may make a traditional forecasting approach extremely difficult. The market value forecast model may overcome these difficulties by implementing the “identify and assign” forecasting methodology. As disclosed herein, the “identify and assign” forecasting methodology may include identifying possible scenarios or assigning probabilities. In some examples, energy services and ancillary services may be referred to as a more general term ‘services.’

As an example of identification of possible scenarios, three years of historical value data may be made into a collection of long vectors: for a particular date, take the energy value of the day and the following day. This may create a vector of 48 entries. The same may be done for regulation-up. regulation-down, or spin values. There may be four vectors of length 48 for each historical date. Take four vectors, put them together and make them into a vector of length 192 (4×48), which may result in having a long vector associated with each historical date.

Further, with regard to identification of possible scenarios, k-means clustering methodologies may be used to profile these long vectors into a set number of clusters by their shapes. However, k-means clustering may utilize Euclidian distance, which may provide the capability to manipulate the significance of the vector entries. Using this characteristic, the vectors may be scaled to have more importance in the near future value shapes and then apply the clustering. The average vector shape of each cluster may represent the scenarios.

Below is an exemplary assignment of probability. Market values may be affected by many factors. Regional load, regional variable generation (e.g., solar, wind, etc.), outages, or previous day values may be indicators of the next hour or next day's values. These variables (e.g., market value data) may be utilized in a machine-learning model that assigns probabilities to the scenarios.

For example, the random forecast machine-learning model (e.g., random forest) and a logistic regression machine-learning model may be used to define probability. The random forest model may be used for classification in addition to forecasting information. In this part of the model, random forest may be used as a classification model and trained to predict which scenario is most likely. A survey of results from all random forest trees may be taken to give a weak classification prediction of each tree and find the probability of each scenario occurrence. The classification prediction of each tree and the probability of each scenario occurrence may be referred to as the first result.

The logistic regression machine learning model may return values between 0 and 1, interpreted as a probability of occurrence for a particular scenario. The logistic regression model may be trained for each scenario and scale the results so that it sums up to one. The sum may provide the second result. Ensemble results (e.g., the first result and the second result) may be generated by averaging the two sets of probabilities associated with the utilized machine-learning models (e.g., logistic regression model and random forecast model).

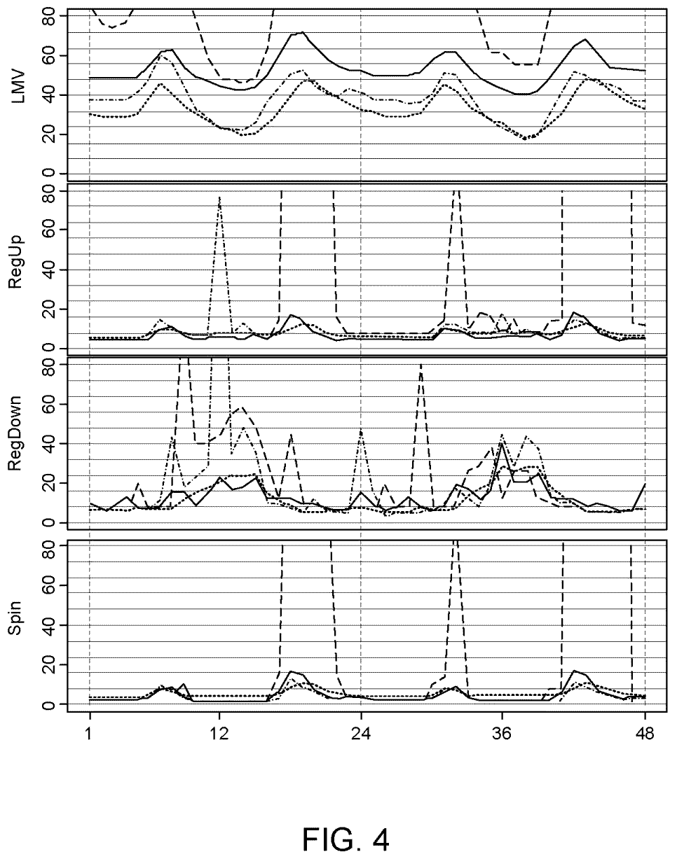

The plot in FIG. 4 shows one instance of a forecast result (e.g., associated with forecasted information) by this modeling methodology. Dotted lines may indicate more probable scenarios, where solid, dotted/dashed, and dashed lines may indicate increasingly less likely but possible scenarios of regulation-up (e.g., RegUp), regulation-down (e.g., RegDown), or spin values spiking at HE12. HE12 (Hour-Ending 12) may refer to consecutive sixty-minute period ending at 12:00, such as, the time period from 11:00 am to 12:00 pm. Locational marginal valuing (e.g., LMV) may also be shown in FIG. 4, where LMV may be a way for wholesale energy values to reflect the worth of energy at different locations, accounting for the patterns of load, generation, or the physical limits of the transmission system. As disclosed herein LMV may also refer to locational marginal pricing (e.g., LMP).

Optimization component 113 may include optimizing the hybrid system (e.g., hybrid system 108) operation for threshold gain (e.g., selected, or preferred level of profit) while taking uncertainties (e.g., variability of the data or forecasted information) into account. Threshold gain as used herein may correspond to a calculated difference in value, such as a calculated profit. The hybrid resource may act as one unit against the grid operation and may be able to follow market dispatch instructions at any moment. This may be accomplished by predicting future renewable energy generation uncertainties, predicting ancillary services dispatch uncertainties, or predicting or keeping enough energy in storage at the right times. The optimization engine (e.g., optimization component 113) may take the data from of DP component 111 or forecast information from forecasting component 112 (e.g., renewable energy generation forecast, market value forecast, or some combination thereof) to find an proposed value strategy for energy services and ancillary services offering based on ISO market rules, wherein ISO market rules may differ based on the ISO, region, etc. In an example, an ISO may specify ISO market rules in a set of documents called a business practice manual (BPM). Proposed value as used herein may correspond to a calculated optimal bidding or bid for a service. In some examples, the proposed value may refer to a bid corresponding to the threshold operational value. The results (e.g., the proposed values) may be saved in the data storage system 116. Some system constraints or proposed value preferences can come from previously defined user inputs associated with a device (e.g., device 102). In some examples, threshold gain may be any value that corresponds or correlates to a calculated increase in profit associated with the operation of hybrid system 108. In some examples, the proposed value may be any bid value for services (e.g., energy services, or ancillary services, among other things) offered. In an example, the highest level of profit may correspond to the selected threshold operational value.

The optimization engine (e.g., optimization component 113) may generate MW—proposed values for future hours. A proposed value for each hour may be divided into segments. Different ISO's (e.g., ISO 121-ISO 124) allow a different number of segments in a proposed value. Each segment may indicate the MW of electricity that the system is willing to charge or discharge and the value range in which it is willing to do so. For example, consider a proposed value for a particular hour with the following two segments: 0.5 MW-$20/MWh and 1 MW-$100/MWh. This implies that if the value is less than $20/MWh then the system would discharge 0.5 MW of electricity in that hour, if the value is between $20/MWh and $200/MWh, the system would discharge 1 MW of electricity in that hour and if the value exceeds $100/MWh then the system may discharge at an upper limit (e.g., calculated maximum) of system capacity in that hour. Self-scheduling proposed values are simpler than MW—proposed values where only a MW value is submitted for each hour. The system will charge or discharge the submitted MW amount at the market clearing value for that hour. The optimization engine (e.g., optimization component 113) has the capability of generating both MW—proposed values as well as self-scheduling proposed values.

The optimization engine (e.g., optimization component 113) may generate proposed values for hybrid resources associated with a hybrid system (e.g., hybrid system 108). Components of a hybrid system 108 may be physically coupled. For example, for a solar+battery hybrid system, solar arrays and batteries may be physically coupled so that batteries can charge from the solar arrays. The components within the hybrid system 108 may share one point of interconnection with the grid and the combined system may participate in any given market.

Energy storage optimization system 110 may participate in day-ahead or real-time markets and provide a variety of services such as energy, regulation up, regulation down, or spinning reserve in these markets. A separate proposed value may be submitted for each of these services in each market and for each participating hour. To generate proposed values, the energy storage optimization system 110 may consider the capacity of each component to provide or consume electricity for each period (e.g., each hour), or market values for different services at each time period.

In some examples, regulation (e.g., regulation-up or regulation-down) may be a reliability product that corrects for short-term changes in energy use that might affect the stability of the hybrid system 108, where regulation may provide the hybrid system 108 with some area control error within acceptable bounds. Area control error may be the difference between scheduled and actual energy generation, which may account for variations in the systems frequency. In some examples, regulation-up may refer to the ability of a hybrid system 108 to provide additional energy generation on command, whereas regulation-down may refer to the ability of a hybrid system 108 to reduce energy generation, or store power, on demand. Spin reserve may be the capacity from which energy generation units already connected or synchronized to the grid can deliver energy within a particular time period (e.g., within 10 minutes) when dispatched. In some examples, a non-spin reserve may be the capacity that can be synchronized to a grid and ramped to a specific load within a particular time period (e.g., within minutes).

Estimating the capacity of each component (e.g., each component of the hybrid system 108) for a future participating period (e.g., hour, or any other suitable period of time) may be challenging; due to the uncertainty of energy generation from variable energy resources, such as solar arrays, or physically coupled components leading to uncertainty in the capacity of a first component causing uncertainty in the capacity of other components as the components exchange energy within the energy storage optimization system 110. Estimating the capacity of each component for a future participating period may further be challenging due to the uncertainty in award or dispatch volumes for different services. For example, if the energy storage optimization system (e.g., energy storage optimization system 110) proposed values 1 MW regulation up discharge for a particular hour, it may be awarded anywhere between 0 MW to 1 MW for that hour. Furthermore, if the system is awarded 1 MW regulation up discharge for a particular hour, the actual energy dispatch may be anywhere between 0 MW to 1 MW for that hour. Lastly, the estimation of component capacity for a future participating period may also be challenging due to the uncertainty of market values used to make charge or discharge decisions for different services.

To account for such uncertainties (e.g., variability in component capacity, or variability in market values, among other things), energy storage optimization system 110 may use a scenario-based model where market values or renewable energy generation scenarios are fed into a mixed integer linear programming algorithm, or the like. The mixed integer linear programming algorithm may provide a methodology for the energy storage optimization system 110 to reach a threshold gain (e.g., a selected gain or an optimized gain) over the entire range of participating hours (e.g., time period). To achieve the threshold gain of energy storage optimization system 110, the mixed integer linear programming algorithm may compare estimates associated with market values for each service over the range of participating hours (e.g., time period) and produces MW—proposed values for each service by considering how each hour's MW—proposed value would affect the capacity of components in the subsequent hours. It is contemplated that any suitable time period may be used in conjunction with the mixed integer linear programming algorithm in an attempt to achieve the threshold gain of the energy storage optimization system 110.

When operating the energy storage optimization system 110 for a threshold operational value, the mixed integer linear programming algorithm may consider constraints. In an example, one constraint considered may be some or all power provided or received via the hybrid system accounted for and balanced with the power distributed within the energy storage optimization system through charge or discharge between the various components (e.g., DP component 111, forecasting component 112, optimization component 113, or HMI component 114). In an example, one constraint considered may be that each component must charge or discharge power within its capacity limits. In an example, another constraint may be that power charged or discharged between the energy storage optimization system or the grid may be limited at the point of interconnection (where interconnection limits are obeyed). In another example, one constraint considered may be the proposed values for each service are constructed such that the cumulative energy dispatched for the services obey charge or discharge limits at the point of interconnection.

Some other example constraints considered may be the end state for some components which may be specified at the end of the optimization period. For example, batteries may need the state of charge to be specified at the end of the optimization period. The charge or discharge behavior of each component may also be a considered constraint in examples where the charge or discharge behavior of each component may be limited to reduce degradation of the components over time.

HMI component 114 may include enabling a user device (e.g., device 102) to display live operations, use input data associated with user inputs to change an operation of a model, use input data to change energy storage optimization system configurations, rerun a model iteratively, or submit the proposed value directly into an ISO system (e.g., ISO 120). In an example, input data may comprise LMV value scenarios, resource charge and discharge capacity, target state of change, regulation participation status and hours, or the like. ISO 120 may collect proposed values from participating energy generators or energy consumers. The collected proposed values may be used in a system value optimization algorithm to determine which energy resources associated with a hybrid resource may be generated at particular time intervals. ISO 120 may send awarded generating energy resources live dispatch signals (e.g., output data) during the operation intervals. Operation intervals may be considered time interval at which the hybrid system has the ability to store or generate energy which may be based on ISO's dispatch signals.

A user device may be operated by a scheduling coordinator, trader, or someone knowledgeable in market participation, among others. The user device may display data (e.g., live data, market data, and the like), forecast information, pre-defined system configuration, or proposed values via a user interface (e.g., user interface 103 of device 102). In a first scenario, the application (e.g., software for energy storage optimization system 110) may provide for display, via user interface 103, data in visual plots that allows for data to be quickly interpreted from different perspectives. The displayed data may include visual comparisons of actual renewable energy generation versus forecast renewable energy generation for past or future power flow among battery energy generation, grid energy generation, or renewable energy generation. The displayed data may include comparisons of the market award or dispatch instructions in association with the actual renewable energy generation versus forecast renewable energy generation data. Device 102, via user interface 103, may further display energy storage optimization system's (e.g., energy storage optimization system 110) operating status or state of charge (SOC) against target SOC levels. In a second scenario, the data may be pulled periodically (e.g., every minute, or any suitable increment of time) from data storage system 116 and displayed, via user interface 103, for end-user system monitoring.

In some examples, optimization engine (e.g., optimization component 113) may be modifiable through the application, or the application may be capable to rerun the optimization on the fly with modified inputs associated with input data. Modified inputs associated with input data may be stored in the memory of server 101 until a rerun happens. When a user reruns the optimization engine, a new set of results may be saved in the data storage (e.g., data storage system 116). A new set of results may be viewable through the application without being sent to the market for proposed values. This configuration associated with the application may enable the end-user to run the optimization model iteratively or stochastically from the application without affecting market proposed values until a satisfactory or optimized result is achieved. Once an end-user may be satisfied with a result, the end-user may proceed with presenting the result to market proposed values directly from the application. The submission of the proposed value may be confirmed from the app. It is contemplated that the optimization model may be a broader component that logically houses the optimization engine which may perform specific, but the terms optimization model and optimization engine are used interchangeably.

The past performance of the energy storage optimization system 110 application (also referred herein as “app”) may also be directly visible through another section of the application. This section may display past energy generation, market values, awards, associated revenue, or summary statistics. This may empower the end-users to study behaviors or build further insights into strategic participation in the market.

The energy storage optimization system 110 may be used by market participants to intervene or manipulate the aspects of a largely automated system. Some or all variables, configurations, or inputs associated with input data may be visible via display or other output interface.

Storage optimization approaches may not assume human involvement in live operations. This may work well when the storage is optimized against the native system load for peak-shaving or other within-system objectives. However, the market (e.g., energy market) may be a dynamically changing environment where users (e.g., scheduling coordinators or traders) may have many insights into what is happening or market trends. In addition to having energy storage optimization system 110 reacting to live market data (e.g., live data) and optimize against the market, the energy storage optimization system may also provide users (e.g., traders) a method to more easily understand the system status, the inputs associated with input data, outputs associated with proposed values, or a way to manipulate the results to achieve dynamically changing multi-objectives.

The following are at least four examples of using the disclosed system:

In a first example, when an extended regional outage is expected (e.g., taking in external data from devices or end-users), which has happened more frequently in California in recent years, objectives may be shifted from a monetary gain associated with energy at market participation to local resiliency The target state of charge (SOC) or control for energy discharge volume may be changed (e.g., via device 102) to ensure there is a satisfactory level of energy in the storage system (e.g., energy storage optimization system 110) by a specific time. In a scenario, a scheduling coordinator may efficiently change the target state using the disclosed system.

In a second example, there may be an indication (e.g., data sent to the system) that a nearby power generating station is likely to go into an outage; therefore, the system may be used to proactively reserve a certain amount of energy in the system for a potential value spike.

In a third example, the hybrid system may require maintenance outages, where it may be advantageous to set the state of charge (SOC) at a particular level beforehand. The target SOC may be set at a specific level for a specific hour.

In a fourth example, when a new system (e.g., a new hybrid system associated with a new hybrid resource) comes online, there may be a need to adjust daily energy and regulation participation volume as the system is proofed or worked on.

In the examples herein, the indications (e.g., triggering data) may be observed by humans (e.g., traders or scheduling coordinators) or obtained via device executed by using data disclosed herein.

Mixed integer linear programming may be a robust algorithm that may allow for optimized solutions, in addition smart simplifications and heuristic constraint settings can sometimes make the algorithm work faster or better. Therefore, enabling a knowledgeable market specialist (e.g., end-user) to access and analyze the live performance data or past performance data can bring meaningful changes to how the model, associated with the energy storage optimization system 110, operates or how constraints are set.

The mixed integer linear programming algorithm may also provide traders (e.g., users or end-users) with the ability to rerun the model with different inputs associated with input data without affecting the actual market proposed value. This configuration may enhance traders' abilities to study the sensitivity to market values, generation forecast (e.g., forecast information), or other system constraints, associated with a hybrid system. As the market rules for hybrid systems are being made at various ISOs (e.g., ISO 121-ISO 124) having usable insights into the system operation enables users to send meaningful feedback to those designing the rules.

Automatic submission into the market is disclosed below. The regular day-ahead or real-time results may be designed to be checked by energy trading professionals before submission. Still, if no intervention is necessary, the proposed values may be automatically submitted to the market at a particular minute of the hour. Some ISOs may enable hybrid systems, associated with hybrid resources, to submit system capacity limits periodically (e.g., every 5 minutes) as an additional tool for managing solar or other renewable energy generation uncertainty. This type of frequent submission may be automated so that there may be no human intervention necessary.

Hybrid system operation is a new market construction in ISO markets, and the disclosed energy storage optimization system may handle uncertainties (e.g., variabilities) specific to hybrid energy resources (e.g., a combination of renewable energy resources and battery energy storage resources under the same meter that acts as one resource from the ISO's perspective). A stochastic forecast is designed for the stochastic optimization formulation in mind, outputting a set number of scenarios with probability. For example, there may be a 5% chance that energy values and regulation-up values may spike, where this may be expressed as a spiking scenario with a 5% probability and such.

In addition, ancillary services dispatch introduces another layer of uncertainties in managing the state of charge (SOC). Historical statistics may be utilized in predicting the correct levels of energy needed to participate in the market.

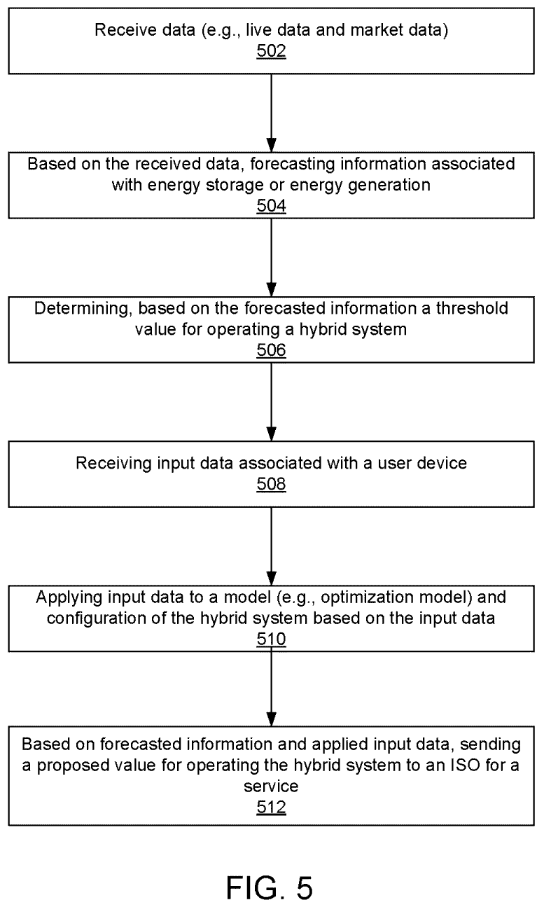

FIG. 5 illustrates an exemplary process of energy storage optimization. At step 502, data associated with a hybrid system (e.g., hybrid system 108) or an independent system operator system (e.g., ISO 120) may be received. The data may be received by energy storage optimization system 110. In some examples, a data processing (DP) component (e.g., DP component 111) of energy storage optimization system 110 may receive live data, which may include system status, the latest solar generation data, on-site metrological data (e.g., location planned for use of energy generation or location for energy consumption), the state of charge of a battery system, or on-site loads, among other things which may be associated with the hybrid system. Further at step 502, energy storage optimization system 110 may receive market data or other data feeds associated with the independent system operator (e.g., ISO 120). In some examples, market data may be sent from ISO 120 directly via an application programming interface (API), from commercial energy data providers, or an organization's (e.g., a scheduling coordinator) internal data management systems. The received data (e.g., live data, market data, or other data feeds) may be processed (e.g., aggregated or adjusted) into a usable format associated with the other components (e.g., forecasting component 112, optimization component 113, or HMI component 114) of the energy storage optimization system 110 for general use. In some examples, the received data may also be stored in a data store (e.g., data storage system 116). In some examples, the data tasks associated with data processing may be set to be continuously or periodically (e.g., scheduled tasks every 5-min or 15-min) processed. It is contemplated that the tasks associated with data processing may be set at any suitable period of time.

At step 504, based on the received data, information may be forecasted, which may be effectuated by forecasting component 112. Forecasting component 112 may forecast future renewable energy generation (e.g., solar, wind, electric vehicle (EV) load, or other energy generation or load) as a range of potential outputs. In another example, there may be a forecasting of market values (e.g., energy value, regulation up value, regulation down value, or spin value), associated with an ISO (e.g., ISO 121-ISO 124), as a set of potential scenarios with likelihood of occurrences. In some examples, correlations between market values may be captured as well as synchronized spiking behavior, such as shown at HE12 in FIG. 4.

In some examples, to forecast information, forecasting component 112 (e.g., forecasting component) may utilize a renewable energy generation forecast model, where a range of possible generations is adjusted based on weather patterns observed in historical generation data. In one example, the renewable energy generation model may utilize a machine learning model, such as random forest to generate expected, high, or low ensemble forecasts.

Forecasting component 112 of energy storage optimization system 110 may further comprise a market value forecast model, which may utilize data received in step 502 or forecasted renewable energy generation data to generate market values. In some examples, the generated market values (e.g., energy, regulation-up, regulation-down, or spin) may be in the form of scenarios and associated probabilities. The generated market value data may be saved back into the energy storage optimization system 110 together with other related data (e.g., data storage system 116) such as the data received in step 502 (e.g., live data, market data, other data feeds, or any combination thereof) or step 504 (e.g., renewable energy generation data associated with the renewable energy generation forecast model). The market value forecast model may further use the received data to determine service (e.g., energy service or ancillary service) market values.

In some examples, service market values may have a strong correlation (e.g., when energy value goes up, regulation-up value most likely goes up too). Both energy services and ancillary service market values may have extreme spikes. For example, a product may be trading at $30 this hour and spike up to $200 in the next hour. This type of multiple-commodity correlation or extreme spiking behavior may make forecasting difficult. Therefore, the market value forecast model of forecasting component 112 may identify possible scenarios (which may be via k-means clustering) or assign probabilities. In some examples, the assignment of probabilities may be provided by a machine learning model such as a logistic regression machine-learning model. In examples, averaged results from the multiple machine-learning models (e.g., logistic regression model and random forest model) may provide a forecast result that may represent trends in the forecasted data.

At step 506, energy storage optimization system 110 may determine a threshold gain for operating the hybrid system. The determination may be via optimization component 113. In some examples, the threshold gain may be sent to hybrid system 108 to optimize hybrid system 108 for a threshold operational value while taking uncertainties (variability) of the data of step 502 or forecasted information of step 504) into account. Optimization engine 113 may analyze the data or forecasted information received, determined, or captured in steps 502 or 504 to find a proposed value strategy for services based on the market. In some examples, the results of the analyzed data may be stored in a data store (e.g., data storage system 116). In an example, hybrid system constraints or proposed value preferences may be referenced based on manual inputs (e.g., input data) received via a user device 102 communicatively linked with energy storage optimization system 110. In an alternative example, optimization engine may generate proposed values for future time periods and determine self-scheduling proposed values.

At step 508, input data associated with a user device may be received. The input data may be captured via user interface 103 of a user device 102. The input data may be sent via network 109 to a server 101 of energy storage optimization system 110. It is contemplated that energy storage optimization system 110 may be a component of server 101 or be a separate device. In some examples, the user interface may provide data that may be stored in a data store (e.g., data storage system 116) of energy storage optimization system 110. The stored data may empower users to study behaviors or build further insights into strategic participation in the market. In some examples, the methodologies and processes of step 508 may be associated with human-centric component (e.g., HMI component 114). At step 510, input data may be applied to a model (e.g., optimization model) and configuration of the hybrid system may be based on the input data. In some examples, some or all variables, configurations, or inputs may be visible to the end-users via user interface (e.g., user interface 103).

At step 512, a proposed value for operating the hybrid system 108 may be sent (e.g., submitted) to an independent system operator (e.g., ISO 121-ISO 124) for a service, based on the forecasted information or applied input data associated with user inputs. In some examples, the sending of the proposed value may be automatic or scheduled at times preferable to the energy storage optimization system or the hybrid system based on the forecasted information or input data associated with user inputs. In alternative examples, the proposed values may be manually submitted in real-time or based on a schedule.

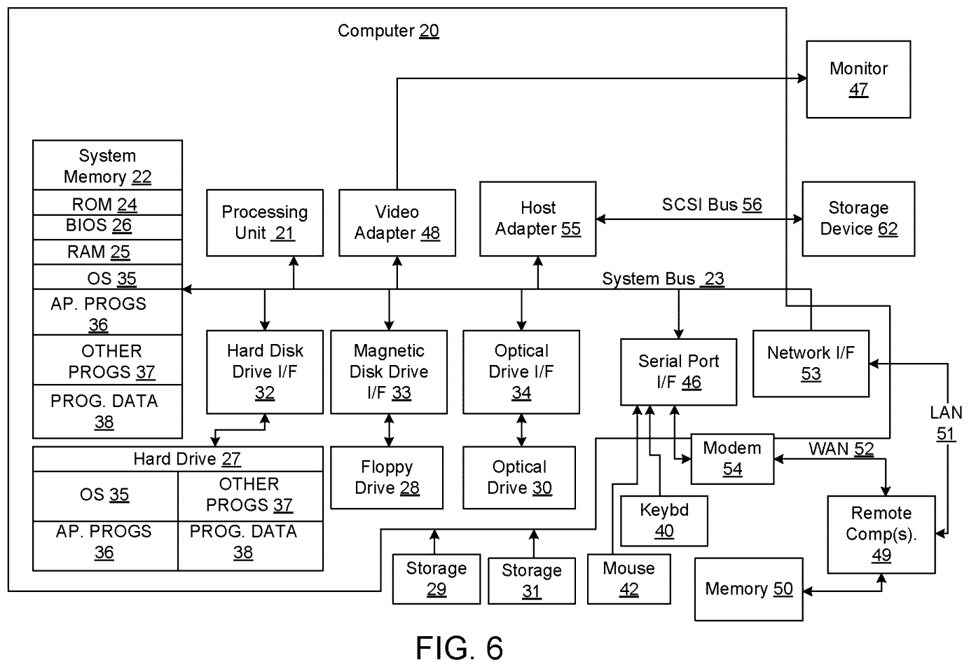

FIG. 6 and the following discussion are intended to provide a brief general description of a suitable computing environment in which the methods and systems disclosed herein, or portions thereof may be implemented, such energy storage optimization system 110, one or more ISOs 120 (e.g., ISO 121-ISO 124), data storage system 116, DP component 111—HMI component 114, or on-site hybrid system 108, among other things. Although not required, the methods and systems disclosed herein are described in the general context of computer-executable instructions, such as program modules, being executed by a computer, such as a client workstation, server, personal computer, or mobile computing device such as a smartphone. Generally, program modules include routines, programs, objects, components, data structures and the like that perform particular tasks or implement particular abstract data types. Moreover, it should be appreciated the methods and systems disclosed herein or portions thereof may be practiced with other computer system configurations, including hand-held devices, multi-processor systems, microprocessor-based or programmable consumer electronics, network PCs, minicomputers, mainframe computers and the like. The methods and systems disclosed herein may also be practiced in distributed computing environments where tasks are performed by remote processing devices that are linked through a communications network. In a distributed computing environment, program modules may be located in both local and remote memory storage devices.

FIG. 6 is a block diagram representing a computing system in which aspects of the methods and systems disclosed herein or portions thereof may be incorporated. As shown, the exemplary computing system includes a computer 20 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read-only memory (ROM) 24 and random-access memory (RAM) 25. A basic input/output system 26 (BIOS), containing the basic routines that help to transfer information between elements within the computer 20, such as during start-up, is stored in ROM 24.

The computer 20 may further include a hard disk drive 27 for reading from and writing to a hard disk (not shown), a magnetic disk drive 28 for reading from or writing to a removable magnetic disk 29, and an optical disk drive 30 for reading from or writing to a removable optical disk 31 such as a CD-ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide non-volatile storage of computer readable instructions, data structures, program modules and other data for the computer 20. As described herein, computer-readable media is an article of manufacture and thus not a transient signal.

This disclosure contemplates that computer 20 may be any electronic device (e.g., device 102) including hardware software, or embedded logic components or a combination of two or more such components and capable of carrying out the appropriate functionalities implemented or supported by the devices 102. As an example, devices 102 may be a computer system such as for example, a desktop computer, notebook or laptop computer, netbook, a tablet computer (e.g., smart tablet), e-book reader, global positioning system (GPS) device, personal digital assistant (PDA), handheld electronic device, cellular telephone, smartphone, other suitable electronic device, or any suitable combination thereof. This disclosure contemplates any suitable device(s) (e.g., device 102). One or more of the devices 102 may enable a user to access a network environment (e.g., network 109 as shown in FIG. 1).

Although the exemplary environment described herein employs a hard disk, a removable magnetic disk 29, and a removable optical disk 31, it should be appreciated that other types of computer readable media which can store data that is accessible by a computer may also be used in the exemplary operating environment. Such other types of media include, but are not limited to, a magnetic cassette, a flash memory card, a digital video or versatile disk, a Bernoulli cartridge, a random-access memory (RAM), a read-only memory (ROM), and the like.

A number of program modules may be stored on the hard disk, magnetic disk 29, optical disk 31, ROM 24 or RAM 25, including an operating system 35, one or more application programs 36, other program modules 37 and program data 38. A user may enter commands and information into the computer 20 through input devices such as a keyboard 40 and pointing device 42. Other input devices (not shown) may include a microphone, joystick, game pad, satellite disk, scanner, or the like. These and other input devices are often connected to the processing unit 21 through a serial port interface 46 that is coupled to the system bus, but may be connected by other interfaces, such as a parallel port, game port, or universal serial bus (USB). A monitor 47 or other type of display device is also connected to the system bus 23 via an interface, such as a video adapter 48. In addition to the monitor 47, a computer may include other peripheral output devices (not shown), such as speakers and printers. The exemplary system of FIG. 6 also includes a host adapter 55, a Small Computer System Interface (SCSI) bus 56, and an external storage device 62 connected to the SCSI bus 56.

The computer 20 may operate in a networked environment (e.g., network 109) using logical connections to one or more remote computers, such as a remote computer 49. The remote computer 49 may be a personal computer, a server, a router, a network PC, a peer device, or other common network node, and may include many or all of the elements described above relative to the computer 20, although only a memory storage device 50 has been illustrated in FIG. 6. The logical connections depicted in FIG. 6 include a local area network (LAN) 51 and a wide area network (WAN) 52. Such networking environments are commonplace in offices, enterprise-wide computer networks, intranets, and the Internet.

In examples where remote computer 49 may be a server, the server may be a unitary server or a distributed server spanning multiple computers or multiple data centers. Servers (e.g., servers 101, 105, 106 as shown in FIG. 1) may be of various types, such as for example, web server, news server, mail server, message server, advertising server, file server, application server, exchange server, database server, proxy server, another server suitable for performing functions or processes described herein, or any combination thereof. In some examples, the servers may be independent of the computing system 20. In such examples, each of the servers (e.g., servers 101, 105, 106) may include hardware, software, or embedded logic components or a combination of two or more such components for carrying out the appropriate functionalities implemented or supported by server (e.g., servers 101, 105, 106).

This disclosure contemplates any suitable networked environment (e.g., network 109). As an example, one or more portions of network 109 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. In some examples, network 109 may include one or more networks 109

When used in a LAN networking environment, the computer 20 is connected to the LAN 51 through a network interface or adapter 53. When used in a WAN networking environment, the computer 20 may include a modem 54 or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used.

Computer 20 may include a variety of computer readable storage media. Computer readable storage media can be any available media that can be accessed by computer 20 and includes both volatile and nonvolatile media, removable and non-removable media. By way of example, and not limitation, computer readable media may comprise computer storage media and communication media. Computer storage media include both volatile and nonvolatile, removable, and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computer 20. Combinations of any of the above should also be included within the scope of computer readable media that may be used to store source code for implementing the methods and systems described herein. Any combination of the features or elements disclosed herein may be used in one or more examples.

In describing preferred examples of the subject matter of the present disclosure, as illustrated in the Figures, specific terminology is employed for the sake of clarity. It is contemplated herein that the periods, renewable energy resources, and machine-learning models are exemplary and do not necessarily limit the implementation of the disclosed subject matter. The claimed subject matter, however, is not intended to be limited to the specific terminology so selected, and it is to be understood that each specific element includes all technical equivalents that operate in a similar manner to accomplish a similar purpose.

This written description enables any person skilled in the art to practice the disclosed subject matter, including making and using any devices or systems and performing any incorporated methods. The patentable scope of the disclosed subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the examples has been presented for the purpose of illustration; it is not intended to be exhaustive or to limit the patent rights to the precise forms disclosed. Persons skilled in the relevant art can appreciate that many modifications and variations are possible in light of the disclosure.

Some portions of this description describe the examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one example, a software module is implemented with a computer program product comprising a computer-readable medium containing computer program code, which can be executed by a computer processor for performing any or all of the steps, operations, or processes described.

The scope of this disclosure encompasses all changes, substitutions, variations, alterations, and modifications to the example examples described or illustrated herein that a person having ordinary skill in the art would comprehend. The scope of this disclosure is not limited to the examples described or illustrated herein. Moreover, although this disclosure describes and illustrates respective examples herein as including particular components, elements, feature, functions, operations, or steps, any of these examples may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates examples as providing particular advantages, examples may provide none, some, or all of these advantages.

Examples also may relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Some examples of the disclosed subject matter are described more fully herein with reference to the accompanying drawings, in which some, but not all examples are shown. Various examples of the disclosed subject matter may be embodied in many different forms and should not be construed as limited to the examples set forth herein. Like reference numerals refer to like elements throughout. As used herein, the terms “data,” “content,” “information” and similar terms may be used interchangeably to refer to data capable of being transmitted, received, or stored in accordance with examples. Moreover, the term “exemplary,” as used herein, is not provided to convey any qualitative assessment, but instead merely to convey an illustration of an example. Thus, use of any such terms should not be taken to limit the spirit and scope of examples.

Examples also may relate to a product that is produced by a computing process described herein. Such a product may comprise information resulting from a computing process, where the information is stored on a non-transitory, tangible computer readable storage medium and may include any example of a computer program product or other data combination described herein.

References in this description to “an example,” “one example,” or the like, may mean that the particular feature, function, or characteristic being described is included in at least one example. Occurrences of such phrases in this specification do not necessarily refer to the same example, nor are they necessarily mutually exclusive.

It is to be understood that the methods, devices, or systems described herein are not limited to specific methods, specific components, or to particular implementations. It is also to be understood that the terminology used herein is for the purpose of describing particular examples only and is not intended to be limiting.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

Without in any way limiting the scope, interpretation, or application of the claims appearing herein, the disclosed subject matter may allow for agile system operation or market participation. Model inputs and outputs may use a human-centric interpretable method which allows restrictions on the solution (e.g., output on the user interface 103) that a user may impose as needed.

The disclosed subject matter may apply to different markets or systems, but entities that serve as scheduling coordinators in ISO markets may see particular benefit, especially since there is an expectation that storage and hybrid resources will increase in many markets. Having a capability to optimize the storage and hybrid assets may be an integral part of scheduling coordinator services.

Methods, systems, and apparatuses, among other things, as described herein may provide for receiving data associated with a hybrid system associated with a hybrid resource(s), or an independent system operator system (ISO); based on the received data, forecasting information associated with renewable energy generation as a range of potential outputs and market values as a set of potential scenarios with a likelihood of occurrences; optimizing the hybrid system for a preferred threshold gain (e.g., threshold operational value) while taking uncertainties (variability) into account associated with the forecasting of renewable energy generation or market values; receiving from users (e.g., end-users) input data associated with a user device inputs to a model and configuration associated with the optimized hybrid system; and based on the optimizing and input data received to the model, submitting or sending a proposed value directly into an independent system operator system. The market values may include energy, regulation up, regulation down, or spin values. The hybrid system may include a combination of storage and renewable energy generation, wherein renewable energy generation may include energy generated by solar, wind, electric vehicle (EV) load, or other energy generation or load. The model may be iteratively or stochastically run with varying inputs from a user (e.g., end-user) or received data. The model may also be run iteratively based on time or scheduling, or user inputs. All combinations in this paragraph or the below paragraph are contemplated herein.

Methods and systems for energy storage optimization may provide human-machine interaction with the system to affect data received, variabilities, and inputs to a model for optimal pricing and use of a hybrid system and its associated hybrid resources. Methods, systems, and apparatuses, among other things, as described herein may perform various processes for the energy storage optimization system. The energy storage optimization model, executable by a processor, that when executed may cause the processor to execute operations to: receive data associated with a hybrid system or an independent system operator system; forecast information associated with market values as a set of potential scenarios with likelihood occurrences; forecast information associated with renewable energy generation as a range of potential outputs; determine, based on forecasted information, a threshold gain for operating the hybrid system while taking uncertainties (variability) into account associated with the forecasted information; receive from user (e.g., end-user) input data associated with a user device inputs to a model and configurations associated with the threshold gain for operating the hybrid system; and send or submit a proposed value directly to an independent system operator system (ISO), based on received input data and the threshold gain for operating the hybrid system. The data received may include live data associated with the hybrid system or market values (e.g., market data) associated with the independent system operator system. The hybrid system may include a combination of storage and renewable energy generation, wherein renewable energy generation may include energy generated by solar, wind, electric vehicle (EV) load, or other energy generation or load. The hybrid system may send live data to the energy storage optimization system for modeling or reporting of data. The independent system operator system may send market data (e.g., market values) to the battery storage optimization system. The market values may include energy, regulation up, regulation down, or spin values. The energy storage optimization model may be iteratively rerun automatically or scheduled by a user. The model may be iteratively or stochastically run with varying inputs from a user (e.g., end-user) or received data. The model may also be run iteratively based on time or scheduling, or user inputs. The data may include live data received from a hybrid system or market data received from the ISO.

What is claimed:

1. A method comprising:
receiving data;
based on the data, forecasting information associated with energy storage or energy generation;
determining, based on the forecasted information, a threshold gain for operating a hybrid system;
receiving input data associated with a user device;
applying the input data associated with the user device to a model and configuration of the hybrid system based on the input data; and
based on the forecasted information and applied input data associated with the user device, sending a proposed value for operating the hybrid system to an independent system operator system for a service.

2. The method of claim 1, wherein the data comprises live data associated with the hybrid system or market data associated with the independent system operator system.

3. The method of claim 2, wherein the live data comprises system status, latest solar generation data, on-site metrological data, state of charge of a battery system, or on-site load.

4. The method of claim 2, wherein the market data comprises market value data.

5. The method of claim 4, wherein the market value data comprises regional market data, regulation up, regulation down, or spin value associated with energy generation.

6. The method of claim 1, wherein the forecasting information comprises determining a future renewable energy generation as a range of potential outputs.

7. The method of claim 6, wherein the future renewable energy generation comprises energy generated by solar, wind, or electric vehicle (EV) load.

8. The method of claim 1, wherein the forecasting information further comprises determining market values, as a set of potential scenarios with likelihood of occurrences.

9. The method of claim 1, wherein the hybrid system comprises a combination of storage and renewable energy generation.

10. The method of claim 1, wherein the model is stochastically run.

11. The method of claim 1, wherein the service comprises an energy service.

12. An energy storage optimization system, executable by a processor, the energy storage optimization system comprising executable instructions to:
receive data;
forecast information, based on the data, associated with energy storage or energy generation;
determine, based on the forecasted information, a threshold gain for operating a hybrid system;
receive input data associated with a user device;
apply the input data associated with the user device to a model and configuration of the hybrid system based on the input data; and
send a proposed value for operating the hybrid system for a service, based on the forecasted information and applied input data associated with the user device.

13. The system of claim 12, wherein the forecast information comprises determining:
a future renewable energy generation as a range of potential outputs; and
market data as a set of potential scenarios with likelihood of occurrences.

14. The system of claim 12, wherein the data comprises a live data associated with the hybrid system, or a market data associated with the independent system operator system.

15. The system of claim 14, wherein the live data comprises state of charge of a battery system or an on-site load.

16. The system of claim 14, wherein the live data received comprises on-site metrological data.

17. The system of claim 14, wherein the market data comprises market value data, wherein market value data comprises regulation up, regulation down, or spin associated with energy generation.

18. The system of claim 12, wherein the hybrid system comprises a combination of storage and renewable energy generation

19. The system of claim 12, wherein the model is stochastically run.

20. The system of claim 12, wherein the future renewable energy generation comprises energy generated by solar, wind, or electric vehicle load.
